(19) United States
(12) Patent Application Publication
(10) Pub. No.: US 2013/0073362 A1
(43) Pub. Date: Mar. 21, 2013

(54) Method and system for rating and evaluating performing artists

(71) Applicants: Michelle Frances Panzironi, Haworth, NJ (US); Alexander Jae Mitchell, McLean, VA (US); Trevor Robert Collins, Demarest, NJ (US); Benjamin Jacob Sklovsky, Montebello, NY (US)

(72) Inventors: Michelle Frances Panzironi, Haworth, NJ (US); Alexander Jae Mitchell, McLean, VA (US); Trevor Robert Collins, Demarest, NJ (US); Benjamin Jacob Sklovsky, Montebello, NY (US)

(21) Appl. No.: 13/507,564

(22) Filed: Jul. 10, 2012

Related U.S. Application Data
(60) Provisional application No. 61/572,139, filed on Jul. 12, 2011.

(51) Int. Cl. G06Q 30/02

(52) U.S. Cl. CPC G06Q 30/0217
USPC 705/14.19

(57) ABSTRACT

A method and system for rating and evaluating music/songs of one or more performing artists includes playing at least two musical performances/songs of one or more performing artists, requesting a third party to indicate a preference of said musical performances/songs, and compensating a provider for determining the preference of the third party. The method and system also enables rating the music/songs of a performing artists by determining a number of different categories/genres of music, assigning a different indicia to each category/genre, assigning a different indicia to each song uploaded onto a system, requesting a third party to listen to one or more musical performances/songs and to designate a preference, and adjusting the numerical scores for the third party's musical category/genre preference by comparing the indicia designated by the third party user with that of the performing artist.

The present application claims the benefit of Provisional Application Ser. No. 61/572,139, filed Jul. 12, 2011, pursuant to 35 U.S.C. 119 (e)(1).

### BACKGROUND OF THE INVENTION

A trend in many current online music radio websites (such as PANDORA.COM and LAST.FM) is music recommendations, where the service “learns” about what music a user likes and offers more music based on that information. These services accomplish this task in various ways, but generally, the services work by manually determining qualitative data about a large number of songs and comparing those songs to each other. The services use that qualitative data to determine what songs a person will like or dislike by allowing the user to like or dislike music on a song-by song basis. A user inputs an existing song about which the service has qualitative data, and the service then gives a series of songs that match that qualitative data. If Song A has five qualitative values and the user indicates that he/she likes that song, and if Song B has those same qualitative values, then the user is likely to also like Song B. If Song C has five qualitative values and a user dislikes Song D that matches that song with four values, the system then knows that the excess value is one that the user dislikes. By supplying hundreds of values to thousands of songs, this method offers an extraordinary level of accuracy.

However, there is a practical downfall to this method. In practice, users are generally looking for new music that they will like, which may or may not sound like music they already know. By using value comparisons, the scope of music being delivered to them is limited to the initial song they input into the system. The problem is simple: extensive qualitative value comparisons make song suggestions too accurate, thereby limiting the scope of music a user can hear by using it. Value comparison is currently the only viable method for a topic as subjective as music, but we believe there is another way to achieve this goal.

### SUMMARY OF THE INVENTION

### I. General Overview of Invention/Business Method

a. A web-based system graphically presents and streams two songs (in a compressed digital media format) to an individual visiting the website (“user”) from a database of music. These songs are uploaded via another part of the website by a musician (“artist”) who participates in the present method sometimes referred to herein as “hypetree”.
b. The user listens to the two songs and then picks which song he/she prefers over the other. The system then presents two more songs in the same way.
c. As the user repeats this process, our program “learns” about the user's musical preferences. This is accomplished by applying a numerical value to a song based on its genre, and then affecting that value depending on its win/losses against other songs' values as well as the user who rates the song's value. This process is outlined in detail in section I.
d. In addition, the system uses the Elo Rating System to apply a numerical score to each song in hypetree's system. These scores are noted and every song on hypetree is ranked based on its score. This process is outlined in detail in section II.
e. The artists are given access to an “analytics” page, where information about each of their songs' performance on hypetree (performance as defined by scores and other data) is displayed on various graphs. See FIGS. 1a and 1b of the drawing. This process is outlined in detail in section II.
f. There are many other aspects/features to the present method, including storing, streaming, uploading, and playing music, creating accounts, etc.
g. As such, the novel processes include three concepts:
   1. A business model where artists pay to promote their music by using a system where two songs are presented to a user and the user chooses one over the other;
   2. A unique program to determine users' musical preferences based on which songs they pick over others;
   3. A method where data about the songs is displayed to the artists graphically so that they can gauge how well their songs are performing

### BRIEF DESCRIPTION OF THE DRAWINGS

FIGS. 1a and 1b schematically illustrate a general overview of the method and system in accordance with the present invention, and graphs generally illustrating analysis of the performing artists in accordance with the present invention;

FIG. 2 is a flow chart illustrating a method and system in accordance with the present invention;

FIG. 3 generally illustrates a method and system for rating in accordance with the present invention; and

FIGS. 4-9 are graphs illustrating a method and system for rating in accordance with the present invention.

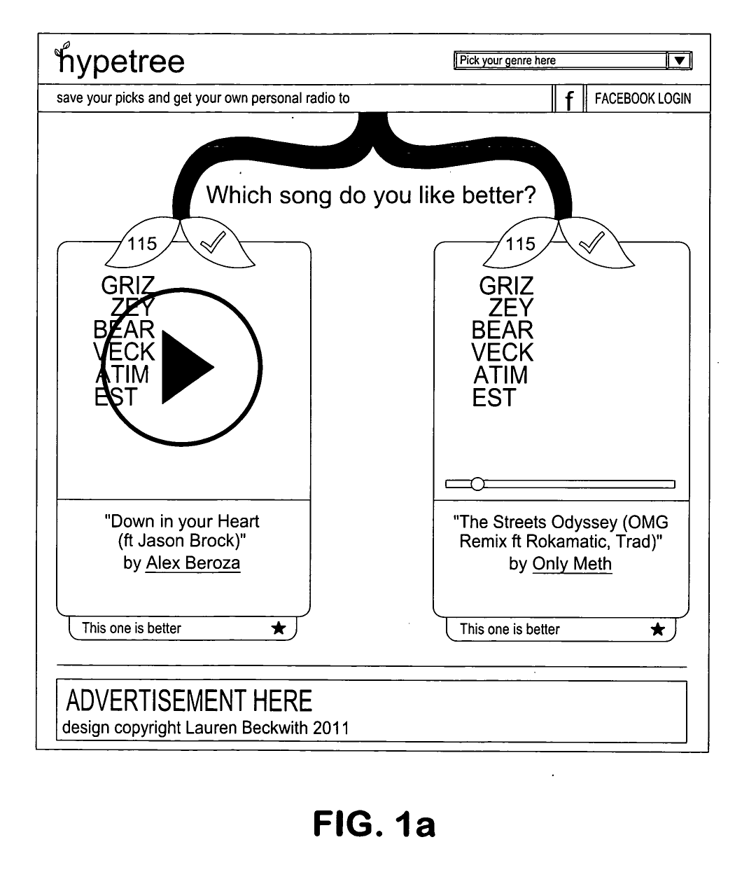

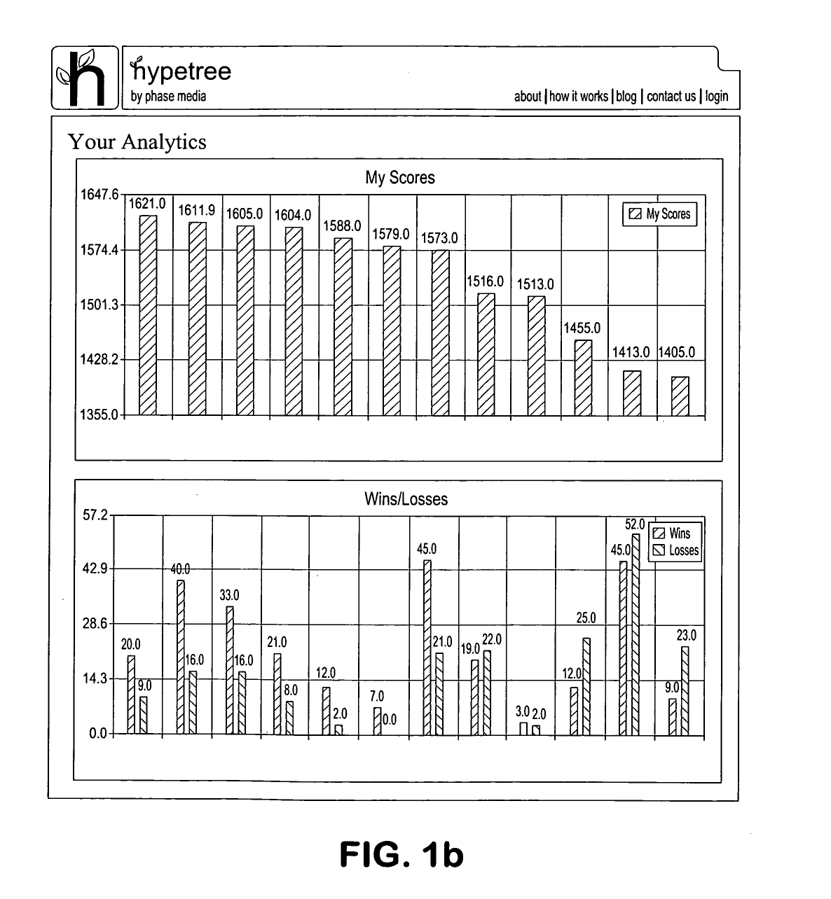

### DESCRIPTION OF THE BEST MODES FOR CARRYING OUT THE INVENTION

Based on a study entitled “Determining and Analyzing the Spectrum of Musical Genre Preference Among Music Enthusiasts” (attached), conducted by Alexander Jae Mitchell, a co-inventor herein, we have developed an alternative method of determining user preferences: value comparisons based on genre, not songs or artists. We discovered that there is a “spectrum of genre preference”—a spectrum of genres that relate to one another in a logical way. In practice, this would mean if a user indicates that he/she prefers a particular genre, that indication can be used to not only recommend songs within that genre but also songs within related genres.

The notion of relationships between these seven genres is a logical one: Rock shares elements like guitar-heavy chording and standout vocal lines with Soft Rock/Country, Pop shares elements of electronic beats with Hip-Hop. What we found in the study is that if someone indicated that he/she prefers the Rock category of genres, there was a specific trend in how that person feels about other related genres, with some genre categories closely related and others not.

A problem that currently exists for many unsigned musicians—but also many signed ones—is honest feedback about their music. Because music is variable by nature, it is nearly impossible to define a song as “good” or “bad.” Furthermore, it is even harder to track how well the public at large reacts to music. We have devised a simple solution to this problem.

### I. Method for Learning User's Musical Preferences

The spectrum discovered in the study is the key to the method for learning user preferences. Our system, unlike any other currently operating, uses this spectrum to suggest songs in related genres to a user. The end goal of this system is to suggest music to users that they may not know they would like, a task accomplished by associating numerical values (customization values, or “CV”) with genres and the user. Before explaining the system behind learning user preference, we must first understand the spectrum. Broken down into seven main categories, the spectrum is as such:

CV 1-10: Instrumental/Acoustic—music consisting of only instruments playing both melody and harmony, with the lack of vocals being the major distinction between this group and the others

CV 11-20: Experimental/Other—music that purposefully does not fit into any of these categories, marked by uncommonly used time signatures and intervals considered odd by non-experimental standards

CV 12-30: Rock/Alternative Rock/Metal—generally loud, guitar-heavy, drum-heavy music

CV 31-41: Soft Rock/Country/Acoustic Singer-Songwriter—sharing elements of Rock, but in a softer way, with less harsh vocals and less intensity

CV 41-50: Jazz/Funk—active or subdued complex music that follows jazz protocol and instrumentation

CV 51-60: Pop/Techno/Dance—beat-heavy music that appeals to the largest group of music consumers

CV 61-70: Urban/RnB/Hip-Hop—soulful, beat-oriented music with rap or shorter vocal lines as opposed to the compositional focus of other beat-heavy music

Within these main genre categories, there are 70 sub-genres. Every time an artist uploads his/her song on to hypetree, he/she must indicate which genre the song belongs to. Each of these sub-genres has a customization value (“CV”) associated with it; for example, the genre of Indie Rock has a CV of 21 as it falls within the category of Rock but also tends to be experimental, whereas the genre of Shoegaze—considered by many to be a subset of Indie Rock—has a CV of 20, as it is closely related. The CVs of all 70 genres are listed in the table below.

| | | CV 21-30: |
|---|---|---|
| CV 1-10: | CV 11-21: | Rock/Alternative |
| Instrumental/Acoustic | Other/Experimental | Rock/Metal |
| Cape Brenton Fiddle 3 | Minimalist 12 | Indie Rock 21 |
| Celtic 3 | New Age 13 | Alternative Rock 22 |
| World 5 | New Wave 14 | Shock Rock 24 |
| Ragtime 4 | Ambient 15 | Post-Rock 25 |
| Classical 8 | Experimental 15 | Emo 26 |
| Instrumental 10 | Avant Garde 15.5 | Pop Punk 26 |
| | Undefined 15.8 | Deathcore 27 |
| | Dubstep 17 | Metal 27 |
| | Turntabllism 17 | Heavy Metal 27 |
| | Drum & Bass 18 | Alternative Metal 27 |
| | Noise 19 | ArnachoPunk 28 |
| | Shoegaze 20 | First Wave Punk 30 |
| | | Second Wave Punk 30 |
| | | Hardcore Punk 30 |

| CV 31-40: Soft | | | |
|---|---|---|---|
| Rock/Country/ | | | CV 61-70: |
| Acoustic | CV 41-50: | CV 51-60: | Urban/RnB/ |
| Singer-Songwriter | Jazz/Funk | Pop/Techno/Dance | Hip-Hop |
| Surf Rock 33 | Calypso 41 | Soul 51 | Dub 61 |
| Britpop 36 | Funk 42 | Gospel 51 | RnB 63 |
| Indie Pop 36 | Jazz 44 | New Jack Swing 54 | G-Funk 64 |
| Acoustic Rock 36 | Blues 45 | Dream Pop 56 | Gangsta |
| Singer- | Doo-Wop 46 | American Pop 56 | Rap 64 |
| Songwriter 36.5 | Merengue 47 | Pop 56 | R&B 64 |
| Folk Rock 37 | Reggaeton 48 | Dance 56 | Hip-Hop 65 |
| Adult 37 | Reggae 48 | Synthpop 56 | Illbient 66 |
| Alternative | | J-Pop 57 | |
| Country 38 | | K-Pop 57 | |
| Country 38 | | Dance 58 | |
| Ska 40 | | House 58 | |
| | | Electronica 60 | |

One of the key features of the present method is the scoring system, based on the equation developed by Arpad Elo for rating chess players. The score is determined by user input when two songs are put in competition for the user's vote. Two songs from the database are presented to the user and the user must pick which song he/she prefers over the other. This is how the scores for songs are generated. This is also how the system learns about user preference.

When the user signs up to participate in the present method, he/she indicates a genre category (from the list on the previous page) that he/she prefers, and optionally a sub-genre. This gives the system a base customization value to reference (“UCV”). When the user picks one song over the other, he/she defines a winning song and a losing song. The system takes the CVs of the losing song and the winning song and compares it to the UCV, and may or may not affect all three values depending on the user's selection.

If the losing song's CV is within the range of UCV−5 to UCV+5, it means that the user should have picked that song to win, as it is within their preferred genre spectrum. For example, let's say a user who has indicated that he/she likes Indie Rock (UCV 21) has the option to pick a song with a CV of 22 (Alternative Rock) or a song with a CV of 36 (Acoustic Rock) (“Case One”), and he/she picks the song with a CV of 36. Since the losing song has a value of 22, which falls within the range of what the system thinks the user would probably like, the system must change that value to reflect the input of the user. In this case, since the winning song's CV is greater than the UCV, the UCV will be raised slightly, to, for example, 21.25. This brings them closer to the value that they picked. If the winning song in this case was not a song with a CV of 36 (Acoustic Rock), and instead a song with a CV of 12 (Minimalist) (“Case 2”), the UCV would be lowered slightly, to, for example, 20.75.

The losing song's value is also affected. Since the winning song in Case 1 was larger than the losing song's value, and the user has indicated that he/she prefers songs within the losing song's CV, it tells the system that the losing song's CV is inaccurate because someone who should have picked it did not. Instead, they picked a song with a greater CV. The logic here is that since the person picked a song with a greater CV, the losing song's CV should also be higher—albeit slightly higher. So the losing song's CV in Case 1 would be updated from 22 to, for example, 22.025. The losing song's CV in Case 2 would be updated from 22 to, for example, 21.925. The rate of change for the case of the losing song is much smaller than that of the case of the UCV.

### Program

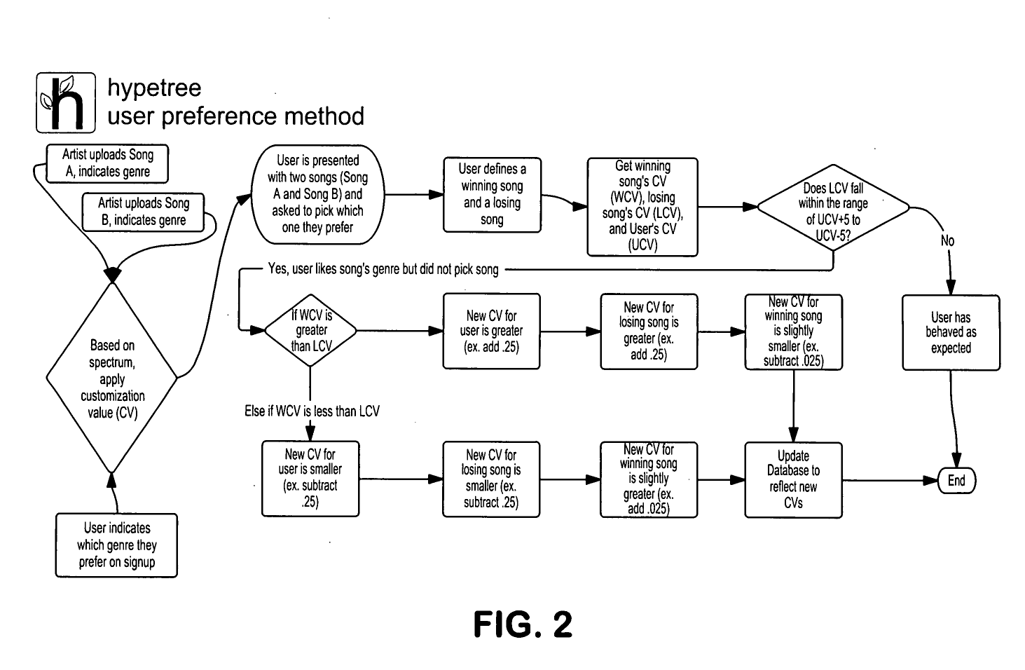

This program as follows, is expressed in code form on the following page, as well as being illustrated in the flow chart of FIG. 2. The code is PHP, excerpted and edited slightly (database name info was excluded) from the code running on the test version of the method system.

Where $a = winning song's CV, $b = losing song's CV, and $c =
user's CV:

if ($a > $b && ( (($c >= ($b−5)) && ($c <= ($b+5))) ) )
{
$newsongvaluefora = $a − 0.025;
$newsongvalueforb = $b + $nb;
$newuservalue = $c + $nc;
if ($newsongvaluefora <= 70 && $newsongvalueforb <= 70 &&
$newuservalue <= 70 && $newsongvaluefora >= 1 &&
$newsongvalueforb >= 1 && $newuservalue >= 1)
{
$setvalue=“UPDATE song_database SET CV=$newsongvalueforb
WHERE song_id =
$losingsongid”;
$setvalueb=“UPDATE user_database SET CV=$newuservalue
WHERE user_id =$fbuser”;
$setvaluea=“UPDATE song_database SET
CV=$newsongvaluefora WHERE song_id =
$winningsongid ”;
mysql_query($setvalue,$con);
mysql_query($setvaluea,$con);
mysql_query($setvalueb,$con);
}
}

By repeating this process numerous times, the UCV eventually reflects their musical taste, and when suggestions for other songs in the database are given to the user, the songs are randomly selected based on the range of UCV+5 to UCV-5; or UCV+2 to UCV−2, depending on the specificity of suggestions the user prefers. For our Case 1 user, a possible song suggestion would be a song with a CV of 27, or 24. When many users repeat this process hundreds or thousands of times, each song on hypetree will have an accurate CV to user ratio, meaning eventually a hypetree song will have a CV that accurately matches up to a user's CV.

### II. Measuring a Song's Performance

### Method

As users pick songs, we collect various bits of data and store it in the database. We can then display that information through the use of dynamically updating graphs to the artist. For example, we can track how many people visit the artist's hypetree profile, and then how many people click through to their pages on MYSPACE, FACEBOOK, etc. When combining this data with data like song scores, wins vs. losses, performance (wins-losses), and user picks/favorites, it paints a clear picture about how well each song a user uploads is doing on our system. Because we use the Elo rating system to determine song scores, the score is not based on individual likes/dislikes, it is based on how that song matches up against every other song on the system. For both industry veterans and indie artists, it provides a non-judgmental way of giving feedback on a per-song basis. To our knowledge, there is currently no system that provides this data directly to musicians via a web interface.

The following is the research paper associated with our method of learning user preferences.

### Brief Introduction to Proposed Study: Determining and Analyzing the Spectrum of Musical Genre Preference Among Music Enthusiasts by Alexander Jae Mitchell (a Co-Inventor Herein)

People do not listen to music like they used to. Compared to individuals' musical habits of past decades, the current ways that people hear music are drastically different; especially with the advent of the internet and portable music technology, there has been an explosion of both music listeners and musical recordings. A trend in many online music radio websites such as PANDORA and LAST.FM has been music recommendations, where the service “learns” about what music a user likes and offers more music based on that information. Generally, the services work by manually determining qualitative data about a large number of songs and comparing those songs to each other. The services use that qualitative data to determine what songs a person will like or dislike by allowing the user to like or dislike music on a song-by song basis; if Song A has five qualitative values and a user dislikes Song B that matches that song with four values, the system then knows that the excess value is one that the user dislikes. By supplying hundreds of values to thousands of songs, this offers an extraordinary level of accuracy.

However, there is a practical downfall to this method. In practice, users are generally looking for new music that they will like that may or may not sound like music they already know. By using value comparisons, the scope of music being delivered to them is limited to the initial song they input into the system. The problem is simple: value comparisons make song suggestions too accurate, thereby limiting the scope of music a user can hear by using it. Value comparison is currently the only viable method for a subject as subjective as music, but I believe there is another way to achieve this goal.

This study aims to bring light to an alternative method of determining user preferences: value comparisons based on genre, not songs. I posit there is a “spectrum of genre preference”—a spectrum of genres that relate to one another in a logical, qualitative way. In practice, this would mean if a user indicates that they prefer a particular genre, that indication can be used to not only recommend songs within that genre but also songs within related genres. The study aims to find a consistent “flow” of related genres by attempting to identify genre preference among music enthusiasts. While ideally the study would include every popular genre to identify this flow, the practical limitations have led to a generalization of genres, broken down in to seven main groups, described as follows:
1. Rock/Alternative Rock/Metal—generally loud, guitar-heavy, drum-heavy music
2. Jazz/Funk—active or subdued complex music that follows jazz protocol and instrumentation
3. Instrumental/Acoustic—music consisting of only instruments playing both melody and harmony, with the lack of vocals being the major distinction between this group and the others
4. Soft Rock/Country/Acoustic Singer-Songwriter—sharing elements of Rock, but in a softer way, with less harsh vocals and less intensity
5. Pop/Techno/Dance—beat-heavy music that appeals to the largest group of music consumers
6. Urban/RnB/Hip-Hop—soulful, beat-oriented music with rap or shorter vocal lines as opposed to the compositional focus of other beat-heavy music
7. Experimental/Other—music that purposefully does not fit into any of these categories, marked by uncommonly used time signatures and intervals considered odd by non-experimental standards

The notion of relationships between these seven genres is a logical one: Rock shares elements like guitar-heavy chording and standout vocal lines with Soft Rock/Country, Pop shares elements of electronic beats with Hip-Hop. Therefore, considering this study is concerned with genre crossover, the hypothesis being tested is that if someone indicates that they prefer the Rock category of genres, there will be a specific trend in how that person feels about other related genres, with some genre categories closely related and others not. Based on existing information including the music history behind the development of these seven genre categories, the hypothesis of this study is that the Rock music enthusiast will like genres in the following order:
1. Rock/Alternative Rock/Metal
2. Soft Rock/Country/Acoustic Singer-Songwriter
3. Experimental/Other
4. Instrumental/Acoustic
5. Jazz/Funk
6. Urban/Hip-Hop/RnB
7. Pop/Techno/Dance

This assumes that the elements someone would enjoy of Rock music are related to the elements of Soft Rock/Country and Experimental more so than they are to Pop and Urban music.

Once the spectrum of genre relationship has been established, the information can be used to improve current music suggestion systems, or serve as the basis for a new one. Genre comparisons will only work if a specific order of the spectrum exists. This study will find its existence in the most objective way possible, display the order, and draw conclusions about its application to music suggestion algorithms/programs

### Study, Findings, Analysis and Conclusion

Methodology

The primary focus in the design of this experiment was to make the results as accurate as possible. While this unfortunately led to a very small sample size, the results from the sample can be considered more accurate due to the nature of the experiment. The most obvious method to go about determining the spectrum of genre preference would be a survey; essentially, ask people who prefer one particular genre of music what other genres they like and do not like. However, this method has numerous holes—the first being the survey respondents may not realize that they like a different genre category as they have not been exposed to it as much as the genre category they prefer. Another problem is bias; if individuals were asked to rate their preferred genres without actually hearing those genres, the results could not be trusted.

The next logical method would be to have individuals listen to songs from different genres and indicate how much they liked that song on some sort of scale. This method has one key problem: the subject in the experiment will definitely rate their preferred genre over other genres due to preconceived preference. It would not be a true test of their genre preference, only a test of how honest they are.

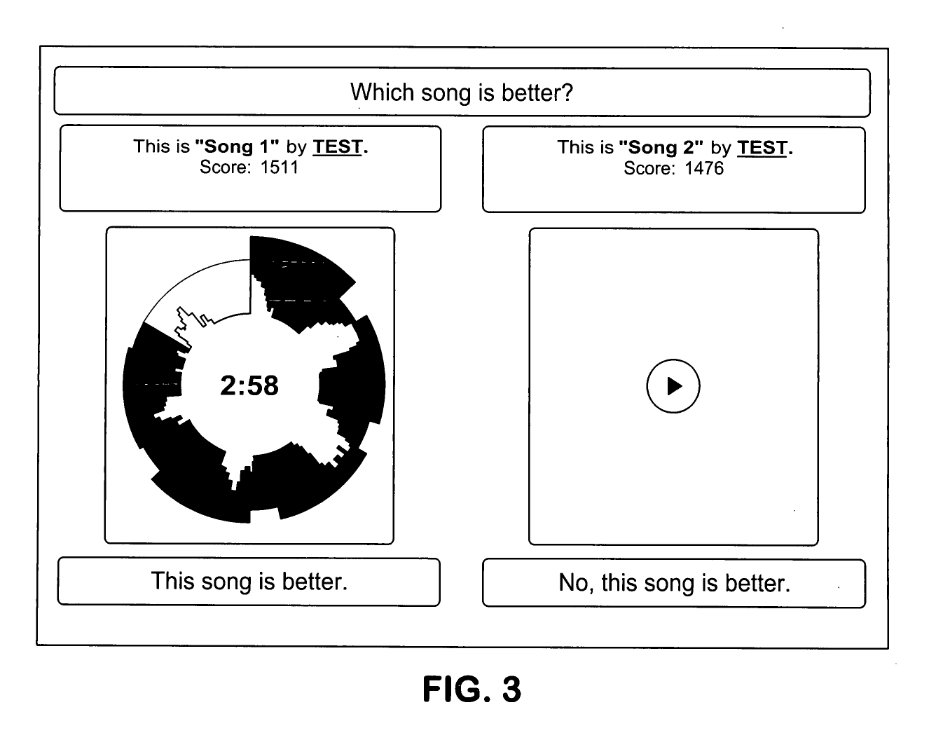

To address these accuracy problems, I developed an experiment that uses the Elo rating system developed by Arpad Elo. His famous equation for rating chess players, “Performance rating=[(Total of opponents' ratings+400*(Wins−Losses))/Games],” serves our purposes perfectly. By presenting two songs from different genres and rating them against each other over and over again, we get the result of how that song was liked based on its relationship to all the other songs that could have been liked, rather than just how much the song was liked. This serves to negate bias, even if a user constantly picks a song in their favorite genre, the result can still come out as a genre contrary to that one depending on the win/loss combination. A web software framework, written in PHP/MySQL, assigns each song a score out of 1500 based on user input (see FIG. 3).

Another hurdle was the individuals tested in the experiment. I decided not to test just anyone; in order to get an accurate reading in the time allotted, I wanted to use individuals who had a background in music and also preferred the same genre category. Five subjects who we will refer to as “music enthusiasts”—either musicians themselves or individuals closely involved with music (one of the subjects runs a music suggestion blog) were picked for the experiment. Because they share the same genre category, we can compare their results consistently, and because they are all involved with music, we can trust that their determining of one song over another was genuine and not taken lightly. They were presented with the following chain of events:
1. Two songs from the list of 14 Songs (more on these songs follows) were chosen “randomly” (using the PHP rand( ) function) and presented to the individual
2. The individual was instructed to listen to both of the songs, and pick one based on which song they enjoyed more
3. After picking, the user was presented with two more songs chosen at random, and this process was repeated 20 times.

The Rating Program

Using the Elo rating system, each song from each of these five sessions was given a score out of 1500. If we go back to the Elo equation, for our purposes it reads as such: [(Total of all other songs' ratings+400*(Number of times selected—Number of times not selected))/Number of times selection program is run]. Once the program had run 20 times for each subject, the song with the highest score was considered the most preferred song of that individual, and its genre was noted. The genre was then noted for all other songs they rated, and depending on the score, the genre relationship spectrum for that individual became apparent. The beauty of the Elo rating system for our purpose was that it also made sure the results were falsifiable—because the framework makes sure that the two songs presented are random, the case was such that sometimes two songs with the same genre category were rated against each other. Each was still assigned a score based on user preference. By rating the control group (same genre category) along with the variable group (different genre category), accuracy was ensured while preserving the integrity of the results.

To add another layer of accuracy to the experiment, two songs indicative of each genre category (fourteen songs total) were picked, and when the results were calculated, the scores (out of 1500) of each song from each genre were averaged together to determine the results.

Findings/Analysis

The goal of the experiment was to use the averaged song scores—determined by the rating system-for each subject to determine the genre spectrum for each individual, and then average those scores together to determine the spectrum for all individuals who participated. The hypothesis was that the spectrum for the music enthusiasts who indicated that they prefer the Rock genre category would follow this pattern (from highest score to lowest score)—
1. Rock/Alternative Rock/Metal
2. Soft Rock/Country/Acoustic Singer-Songwriter
3. Experimental/Other
4. Instrumental/Acoustic
5. Jazz/Funk
6. Urban/Hip-Hop/RnB
7. Pop/Techno/Dance
and the results of the experiment, while different from the hypothesis, seemed to indicate a trend that was at the very least quite similar to the hypothesis. Individually, the spectrum obviously varied from subject to subject, but there was a clear trend: the subjects, who all indicated that they preferred the Rock genre category, generally scored the songs from the Urban genre category lower than the others. After averaging all the results from all of the subjects, the genre preference spectrum came out as such (from highest scored genre to lowest, the > indicates a correct hypothesis position):

| | |
|---|---|
| 1. >Rock/Alternative Rock/Metal | 1522.9 |
| 2. Jazz/Funk | 1518.1 |
| 3. >Experimental/Other | 1513 |
| 4. >Instrumental/Acoustic | 1489.7 |
| 5. Soft Rock/Country/Ac Si/So | 1485.3 |
| 6. Pop/Techno/Dance | 1483 |
| 7. Urban/Hip-Hop/RnB | 1483 |

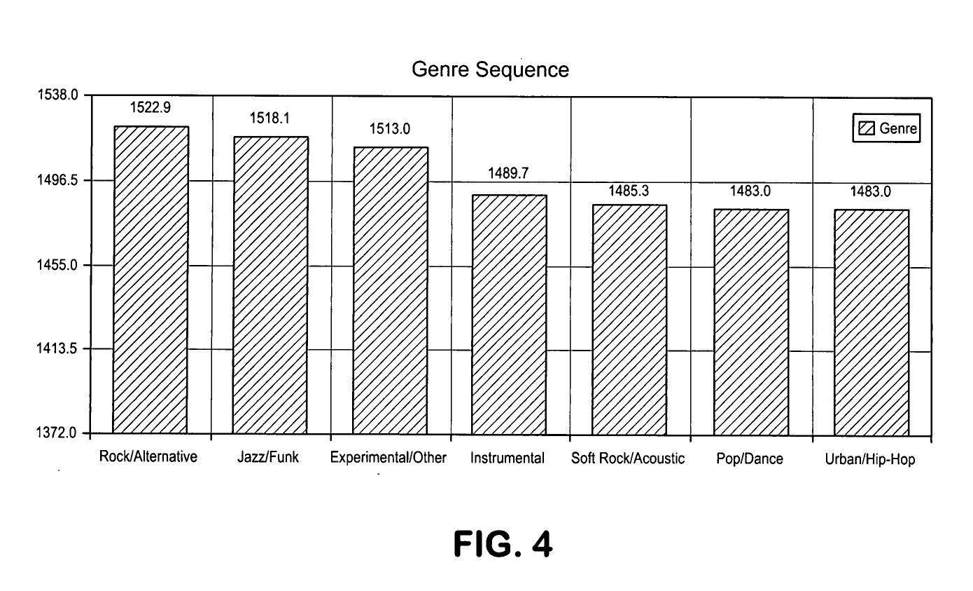

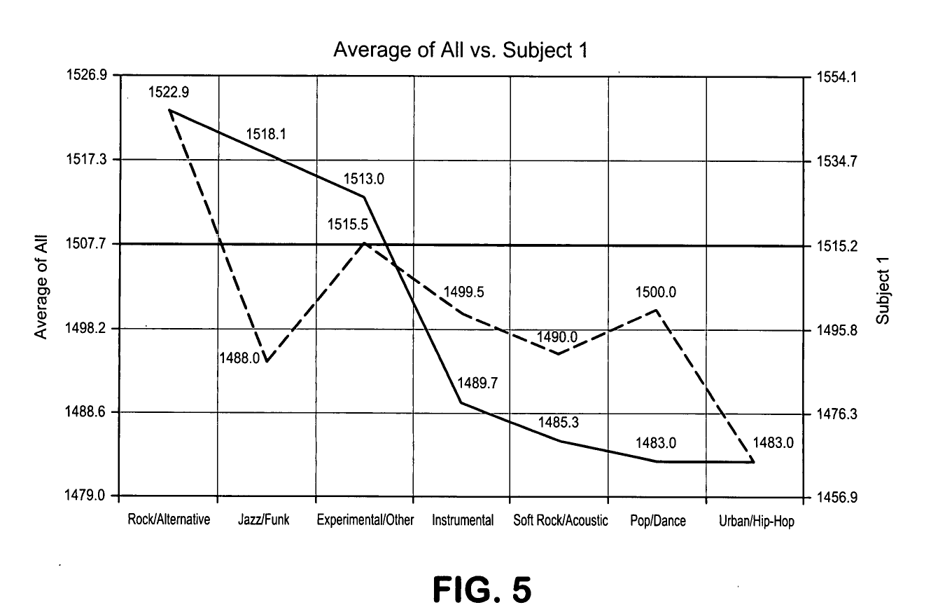

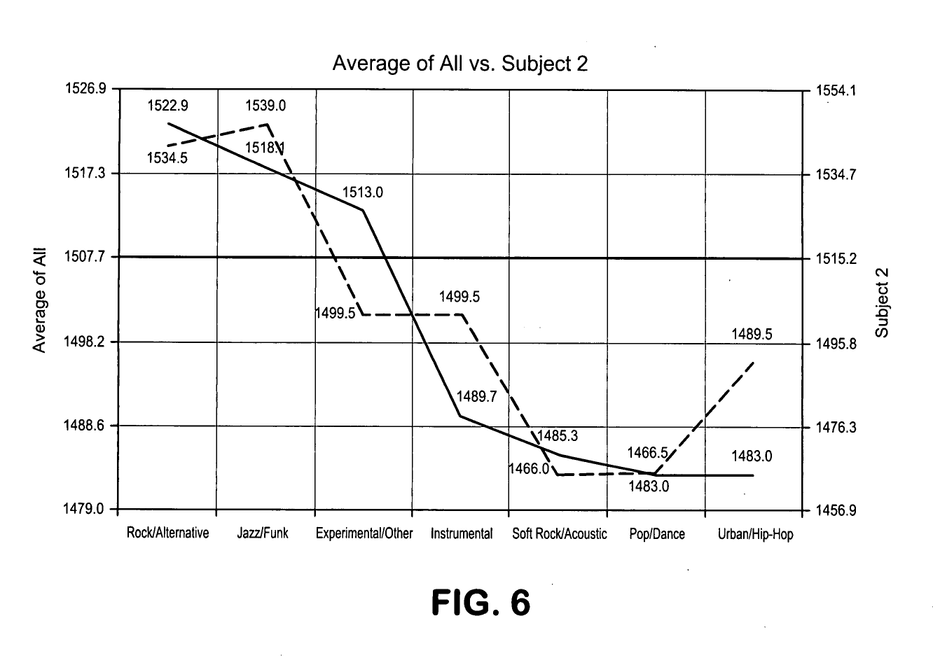

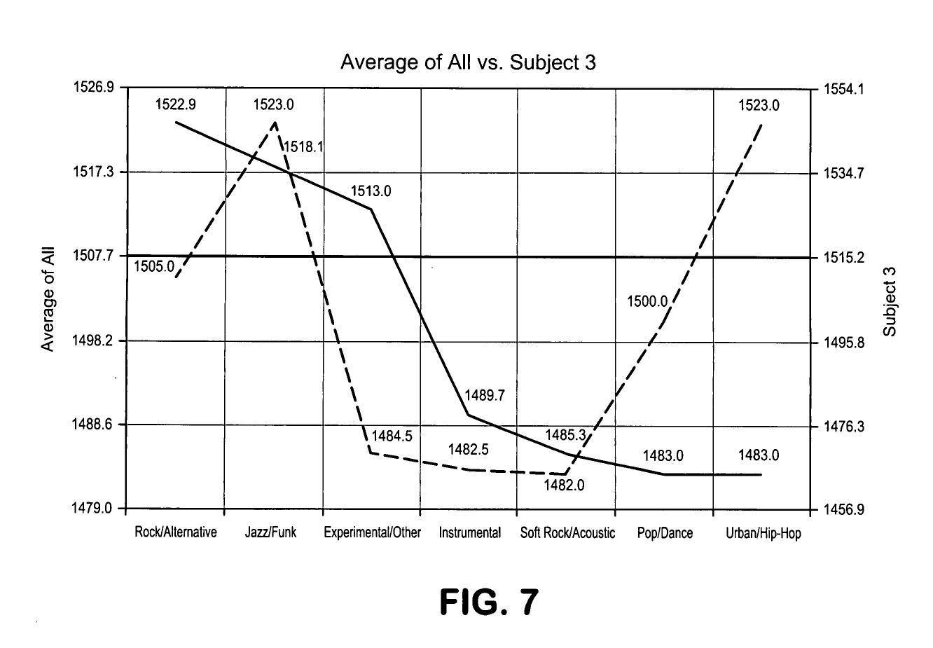

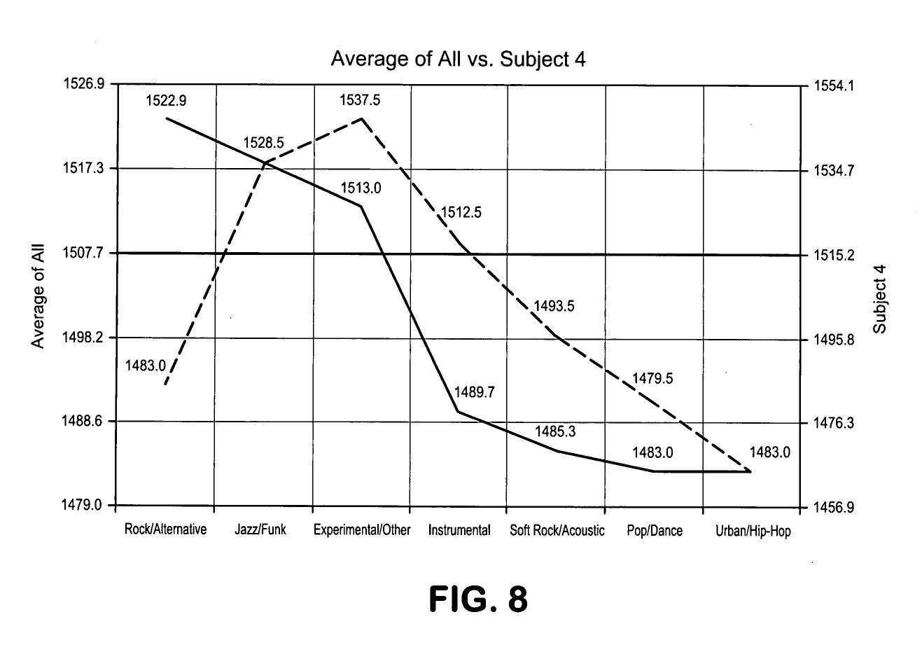

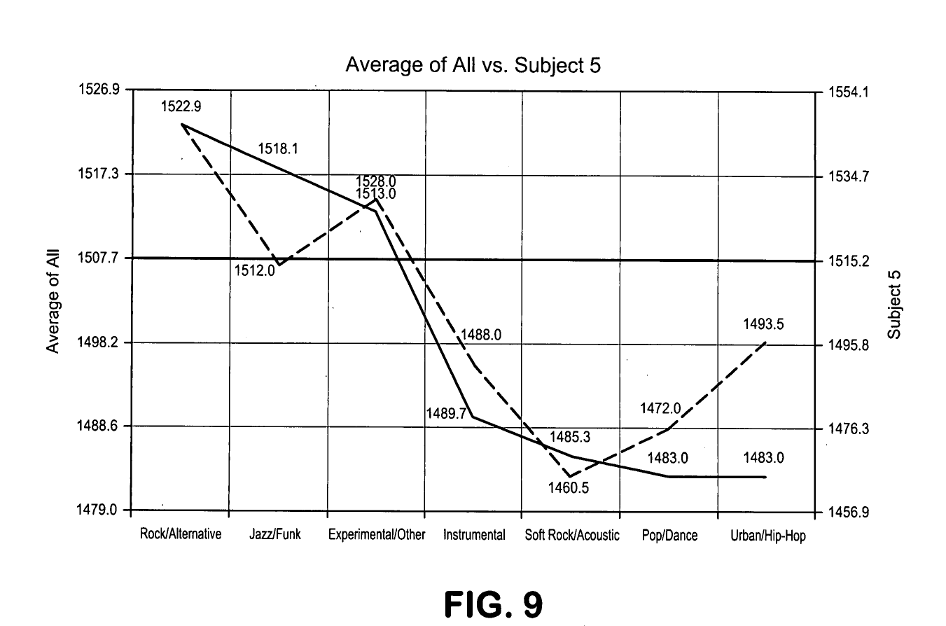

The data is broken down in the following graphs designated as FIGS. 4-9, respectively. The bar graph shows the averaged Elo score out of 1500 according to the spectrum of the results. Each of the line graphs displays the subject's scores with the average of all the scores to indicate whether or not that subject fit the trend—these graphs are also ordered according to the result spectrum. See FIGS. 4-9.

If we think of the averaged results (See FIGS. 4-9, unbroken/solid line) as the line of best fit, it becomes apparent that the spectrum results accurately depict the overall genre preference of the group. While subject 3 can definitely be considered an outlier, the experiment made sure to represent all views fairly, as subjects 2 and 5 both clearly follow the average. It's also interesting to note in the averaged results that there is a clear drop-off in terms of the three higher rated genre categories and the four lower genre categories, implying that the subjects like rock, jazz, and experimental music considerably more than they do instrumental, soft rock, pop and urban music.

These results clearly support the notion of genres as Neo-Tribes from the previous literature review. All of the subjects identified as being part of the genre group of Rock, which we can conclude is a Neo-Tribe. Considering the previous research into Neo-Tribalism as it relates to musical genres, we can now support our simple yet necessary conclusion based on the data: people who belong to the Neo-Tribe of rock genre preference generally will prefer a rock, jazz, or experimental song over a song that is hip hop, rnb, or soul. The similarity of the five graphs demonstrates this conclusion; all the line graphs—with the exception of subject 3—follow more or less the same pattern. This similarity in pattern suggests a similarity in the subjects, further supporting the notion of Neo-Tribes. While this experiment cannot also definitively conclude that a member of the Neo-Tribe of hip hop will also prefer a song from that genre over a song that is from our genre category of rock, it is not an unreasonable conclusion based on the data collected.

Furthermore, we can also conclude that Rock and Pop are not related, in direct contrast to the way labels have categorized music in the past. The previously discussed research by Pachet & Cazaly indicated that labels usually dictated genre categories, and a practical application of this relationship is apparent in CD stores, where rock and pop are included in the same rack. This is most likely because Pop and Rock are the two best selling genre categories, but our data suggests that not only are they not closely related, they are directly opposite of each other in terms of user preference. In only one out of the five cases did the subject prefer pop and urban to rock.

But the more interesting question to answer is: why? Why did the rock-preferring subjects rate the pop songs so low? Jukka Holm, Harri Holm, and Jarno Seppänen's study “Associating Emoticons with Musical Genres” showed us that rock music is generally equated with an unhappy emoticon ( [symbol] ), while pop music is generally equated with a happy emoticon ( [symbol] ). Combining those results with the results of this study, it is not to say that the subjects of our study were unhappy people, rather, we can see the obvious distinction between the upbeat mood of pop music and the general intensity of rock music. At the risk of generalizing, it is safe to say that the subject matter of rock music in terms of lyrical content is usually much sadder than that of pop music. Again, while our data does not necessarily prove this correlation, it is interesting to note that the two genres on opposite ends of the spectrum in terms of preference are also the genres that are on the opposite ends of the spectrum in terms of mood. This would support the commonly held claim that people listen to music depending on their mood or personality type.

Areas of Weakness/Suggestions for Future Study

The major weakness of this study is obviously its small sample size. Bigger sample sizes mean more accurate data, but unfortunately the situation was such that this experiment had to be done on a small scale due to its practical limitations (because of the system design, all data had to be reset after every subject participated, so the experiment could not be publicly accessed by a large base) and due to the fact that the sample size was limited to only individuals that liked a particular genre and were musicians or music experts. A future run of this study could include much more people if the system were re-designed.

Another pitfall is the wide generalizations in terms of the seven categories themselves—a workaround to this would be to include fifty to a hundred genres that encompass virtually all sub-genres an individual could like, and generate data from all of the sub-genres to better reflect a larger spectrum. Again, this could not be done due to the practical limitations.

### CONCLUSION

This study aimed to find a correlation between genre likes and dislikes, and after receiving such clear data trends on the subject, I believe this goal has been met. The data suggests that there is a clearly defined spectrum of genre preference among individuals who identify as preferring a particular genre. In combination with the previous research outlined in the literature review, I have also drawn the conclusions that 1) The musical preferences of individuals who like a certain genre are consistent from person to person, 2) Labels and music marketers should not market Rock music alongside Pop music, as these genres are in direct opposition to each other, and 3) Individuals pick music based on their mood.

Earlier, I also discussed the relevance of this data to improving current music suggestion systems. As previously stated, one current downside to music suggestion algorithms/programs is that they do not allow for genre crossover, as they do not allow for fluidity. But as subject 3 demonstrates, there is always fluidity when determining what music a person likes. There are few people who try to discover new music that sounds just like the music they already listen to. This spectrum of genre preference is one way to prevent this from happening: while I've spent a lot of time talking about how Pop and Rock are opposite, we can also use this data to say, almost definitively, that individuals who like Rock music also like Jazz and Experimental genre categories. As such, when improving a music suggestion system, this data can be used to suggest songs from the Jazz and Experimental genre categories to someone who has indicated they primarily like Rock. While this music may not necessarily fall directly into the category of music that the individual generally hears, it will promote music discovery more effectively, which ought to be the ultimate goal of a music suggestion system in the first place.

The functioning and operation of the systems and methods of the present invention disclosed herein, including the running of the computer programs, preferably is accomplished by a general purpose computer, which will clearly be known to and understood by persons of ordinary skill in the relevant.

Other features of the invention and variations thereof will become apparent to those skilled in the art based upon the present disclosure. Accordingly, the present disclosure is directed to the preferred embodiments of the invention and is not intended to limit the scope of the invention, that scope being defined by the following claims and all equivalents thereto.

1. A method for rating and evaluating music/songs of one or more performing artists, the steps of said method including:
playing at least two musical performances/songs of said one or more performing artists for a third party by a provider;
requesting said third party to indicate a preference of said music performances/songs; and
compensating said provider either directly or through advertising revenues for determining the preference of said third party.

2. The method according to claim 1, further including the step of:
selecting at least one other musical performance/song to be played for said third party based upon said preference indicated by said third party.

3. A method for rating the music/songs of a performing artist, the steps of said method including:
defining a predetermined number of different categories/genres of music;
assigning a different indicia to each of said predetermined categories/genres of music;
assigning a different indicia to each of said songs uploaded onto said system;
requesting a third party user to designate said user's preferred category/genre of music;
requesting a third party user to listen to one or more musical performances/songs and designate said user's preferred musical performances; and
adjusting the numerical scores for third party user's musical category/genre preference and song category/genre based on preferences of said third party user by comparing the indicia assigned to said categories/genres of music designated by said third party user and by said performing artist.

4. The method as claimed in claim 3, wherein the categories of music include at least one from the group of: instrumental; experimental; alternative; country; jazz; pop; and hip-hop/rhythm and blues.

5. The method as claimed in claim 3, further including the step of generating graphs and charts reflective of the performance of said musical performances/songs of said performing artists.

6. The method as claimed in claim 3, further including the step of suggesting other musical performances/songs to said third party user based upon the rated preferences of said third party user.

7. The method as claimed in claim 3, further including the step of predicting other musical performances/songs likely to be preferred or purchased by said third party user based upon the rated preferences of said third party user.

8. The method as claimed in claim 3, further including the step of storing said preferences of said third party user in a database.

9. The method as claimed in claim 3, wherein said performing artist assigns different indicia to each of said songs uploaded onto said system.

10. The method as claimed in claim 3, including the steps of:
further requesting a third party user to listen to one or more musical performances/songs and designate said user's preferred musical performances/songs; and
further adjusting the numerical scores for third party user's musical category/genre preference and song category/genre based on preferences of said third party user by comparing the indicia assigned to said categories/genres of music designated by said third party user and by said performing artist.

11. A system for rating the music/songs of a performing artist, said system including:
means for defining a predetermined number of different categories/genres of music;
means for assigning a different indicia to each of said predetermined categories/genres of music;
means for assigning a different indicia to each of said songs uploaded onto said system;
means for requesting a third party user to designate said user's preferred category/genre of music;
means for requesting a third party user to listen to one or more musical performances/songs and designate said user's preferred musical performances; and
means for adjusting the numerical scores for third party user's musical category/genre preference and song category/genre based on preferences of said third party user by comparing the indicia assigned to said categories/genres of music designated by said third party user and by said performing artist.

12. The system as claimed in claim 11, wherein the categories of music include at least one from the group of: instrumental; experimental; alternative; country; jazz; pop; and hip-hop/rhythm and blues.

13. The system as claimed in claim 11, including means for generating graphs and charts reflective of the performance of said musical performances/songs of said performing artists.

14. The system as claimed in claim 11, including means for suggesting other musical performances/songs to said third party user based upon the rated preferences of said third party user.

15. The system as claimed in claim 11, including means for predicting other musical performances/songs likely to be preferred or purchased by said third party user based upon the rated preferences of said third party user.

16. The system as claimed in claim 11, including means for storing said preferences of said third party user in a database.

17. The system as claimed in claim 11, wherein said performing artist assigns different indicia to each of said songs uploaded onto said system.

18. The system as claimed in claim 11, including:
means for further requesting a third party user to listen to one or more musical performances/songs and designate said user's preferred musical performances/songs; and
means for further adjusting the numerical scores for third party user's musical category/genre preference and song category/genre based on preferences of said third party user by comparing the indicia assigned to said categories/genres of music designated by said third party user and by said performing artist.
